(19) United States
(12) Patent Application Publication
(10) Pub. No.: US 2014/0379408 A1
(43) Pub. Date: Dec. 25, 2014

(54) Invitee-Driven Calendar Appointment Duration Reduction

(71) Applicant: TimeTrade Systems, Inc., Tewksbury, MA (US)

(72) Inventor: Brian Kelly, Tewksbury, MA (US)

(21) Appl. No.: 14/310,084

(22) Filed: Jun. 20, 2014

Related U.S. Application Data
(60) Provisional application No. 61/837,683, filed on Jun. 21, 2013.

(51) Int. Cl. G06Q 10/10

(52) U.S. Cl. CPC G06Q 10/1095
USPC 705/7.19

(57) ABSTRACT

A calendar appointment invitation is displayed. The invitation includes a user selectable initial time slot having an initial duration, and a user selectable option to shorten the initial duration. If a user selects the initial time slot and the shorten option, the appointment is scheduled for a shortened time slot having a duration that is shorter than the initial duration and that is within the initial time slot. If the user selects the initial time slot but not the shorten option, the appointment is scheduled for the initial time slot.

### CROSS REFERENCE TO RELATED APPLICATION

This application claims priority to U.S. Provisional Application No. 61/837,683 filed Jun. 21, 2013, the entirety of which is incorporated herein by reference.

### TECHNICAL FIELD

The present disclosure relates to flexible, automated, calendar appointment scheduling.

### BACKGROUND

Meeting/appointment scheduling is a way in which a service provider can interact with its clients/customers. Online/web-based appointment scheduling has become a prevalent tool used to allow a user to schedule appointments with service providers and/or clients. To schedule an appointment using conventional techniques, an inviter sends an appointment invitation to an invitee. The invitation displays an appointment time slot of a fixed duration set by the inviter that the invitee can either accept or reject. In this sense, the invitation is inviter-driven. The invitee may wish to accept the appointment; however, if the invitee is only available for a limited portion of the time slot, the invitee may be forced to reject the invitation.

### SUMMARY

Presented herein are techniques for invitee-driving appointment scheduling in which the invitee is permitted to reduce a duration of an initially offered appointment. An invitation for an appointment is displayed to an invitee. The invitation includes a user selectable initial time slot having an initial duration, and a user selectable option to shorten the initial duration. If the initial time slot and the shorten option are selected, the appointment is scheduled for a shortened time slot having a duration that is shorter than the initial duration and that is within the initial time slot. If the initial time slot is selected and the shorten option is not selected (and a continue scheduling option is also selected), the appointment is scheduled for the initial time slot.

### BRIEF DESCRIPTION OF THE DRAWINGS

FIG. 1 is a block diagram of an example calendar system in which invitee-driven scheduling of an appointment of a shortened duration may be performed.

FIG. 2 is an illustration of an example user interface that represents an appointment invitation including a user selectable option to shorten a duration of an appointment.

FIG. 3 is an illustration of an example user interface that presents user selectable shortened appointment durations.

FIG. 4 is an illustration of an example user interface that presents shortened appointments relative to the initial appointments offered in the invitation of FIG. 2.

FIG. 5 is a flowchart of an example generalized method of invitee-driven scheduling of an appointment in which the invitee may reduce initially offered appointment durations.

FIG. 6 is a block diagram of an example server configured to perform the techniques described herein.

### DETAILED DESCRIPTION OF EXAMPLE EMBODIMENTS

Techniques presented relate to an appointment scheduling system that supports sending of an invitation to a user (“invitee”) with multiple choices of initial time slots at which to create an appointment. The system provides a mechanism to represent a way for the invitee to reduce the duration of the appointment being offered to allow it to fit into the invitee's own schedule, and thereby also increase the number of available appointments that the invitee may schedule.

For example, the invitee receives an invitation from an inviter to meet with the inviter for 1 hour, and to choose between the time slots of 2-3 pm and 5-6 pm. Unfortunately, the invitee is completely busy from 9 am through to 5:30 pm, therefore leaving 5:30 pm-6 pm as the only potential time to meet. The system allows the invitee to shorten the length of the inviter's requested meeting to fit into the invitee's calendar, thereby allowing the invitee to book 30 minutes of time with the inviter from 5:30 pm-6 pm. This is an example of invitee-driven appointment scheduling.

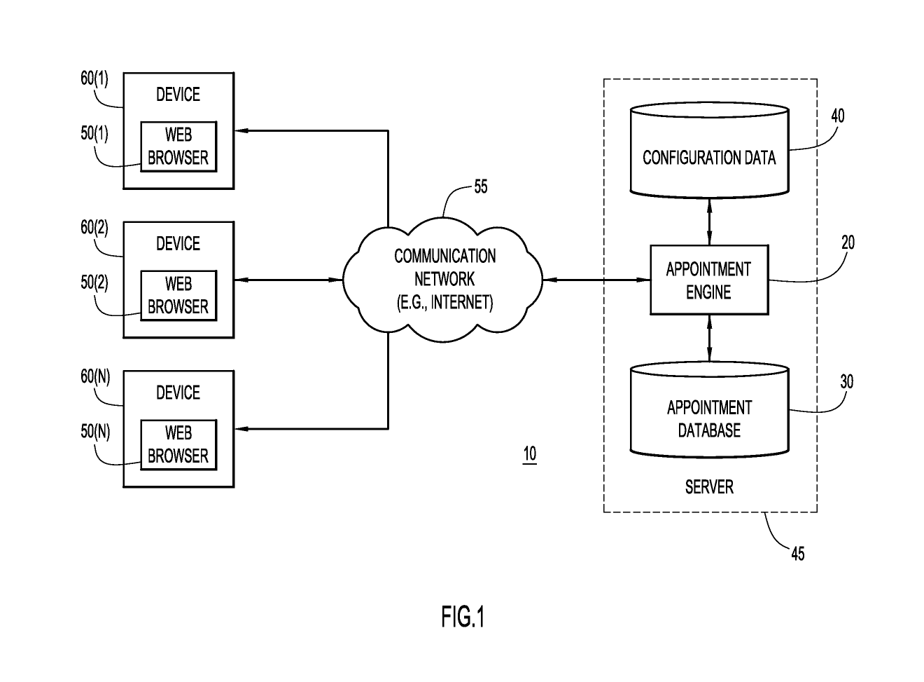

FIG. 1 shows an arrangement of a calendar/appointment system in which invitee- driven scheduling of an appointment may be performed. The system, shown generally at reference numeral 10, includes an appointment engine 20, an appointment database 30 and a data repository 40 that stores configuration data. The appointment engine 20, appointment database 30 and configuration data 40 may be managed/run by one or more applications on a server 45. The appointment engine 20 communicates with web browsers 50(1)-50(N) by way of a communication network, e.g., the Internet, shown at reference numeral 55. A different user is associated with each of the web browsers 50(1)-50(N). Moreover, the web browsers 50(1)-50(N) are running within user devices 60(1)-60(N), respectively. Data for appointments is stored in the appointment database 30. The operations of the server 45 may be performed by one or more applications running in a data center/cloud computing environment.

The system depicted in FIG. 1 may be used to implement invitee-driven scheduling of an appointment, where the invitee may shorten an initially offered duration of the appointment, as mentioned above and described in detail below. As used herein, the terms “schedule” and “book” (and there respective derivatives) are interchangeable and synonymous. While the example calendar system of FIG. 1 is web-based, it is to be understood that the automatic scheduling techniques described herein may also be implemented as a non web-based or stand-alone calendar system. Such a stand-alone calendar system may be implemented as a stand-alone computer program application executed on a personal computer-based platform, such as a laptop computer or tablet, Smartphone, and the like.

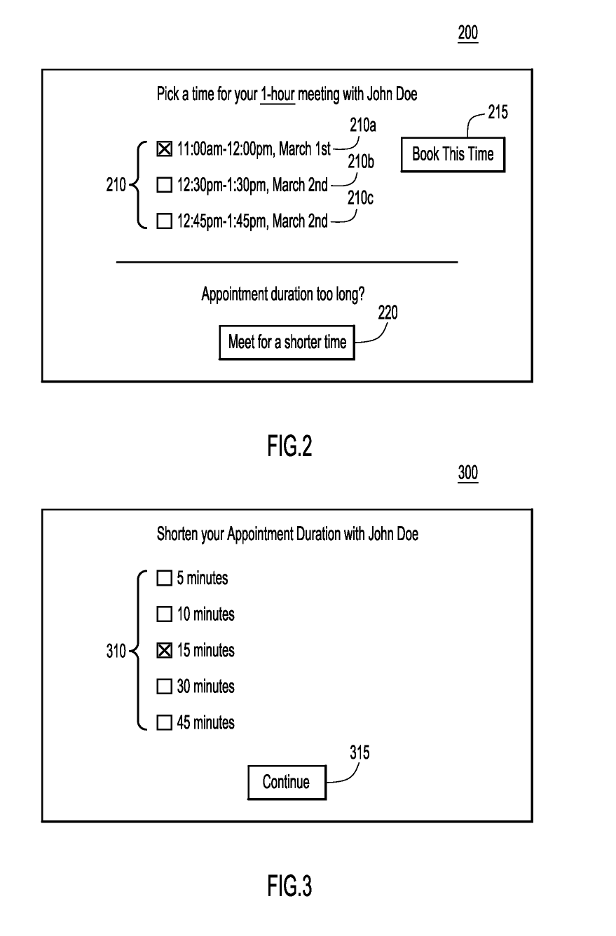

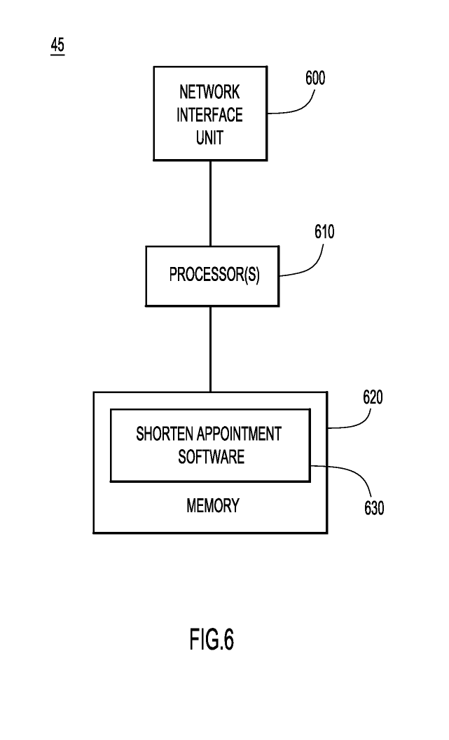

An example invitee-driven appointment scheduling scenario used to reduce a duration of an appointment is now described with reference to a sequence of example graphical user interfaces (GUIs) depicted in FIGS. 2-4. After the example scenario is described, a generalized method of invitee-driven scheduling to reduce appointment duration will be described in connection with FIG. 5.

Initially in the example scenario, a first user (the “inviter”) creates a calendar appointment invitation using a graphical user interface (GUI) presented or displayed on web browser 50(1), and sends the invitation to web browser 50(2) for presentation thereby to a second user (the “invitee”). The inviter creates the invitation so that:
a. the invitation offers multiple initial appointment time options (i.e., user selectable appointment time slots) of 11:00 am-12:00 pm, 12:30 pm-1:30 pm, and 12:45 pm-1:45 pm. In the example, the appointment time slots all have the same original/initial duration of 1 hour, but mixed durations are possible;
b. the invitation will allow the invitee to shorten the initial time slot duration of 1 hour to a shortened time slot duration (e.g., 15 minutes or 30 minutes) that is convenient for the invitee. Shortened duration times may be embedded in the invitation as metadata and may be selected by the inviter or predetermined; and
c. any shortened time slots will have start times that align with successive regular time boundaries, e.g., on the hour, quarter hour, half hour, three quarter hour, etc. The time boundaries are embedded in the invitation. The time boundaries may be embedded as metadata and may be selected by the inviter or predetermined.

Web browser 50(2) receives the appointment invitation sent by the inviter and displays the invitation, as depicted in FIG. 2.

With reference to FIG. 2, there is depicted a first example user interface 200 (also referred to as an “invitation 200”) displayed on web browser 50(2) representative of the invitation received by the invitee. Invitation 200 includes multiple user selectable initial time slots or appointment times 210a, 210b, and 210c (collectively referred to at 210) and a user selectable “book this time” option 215 that, when selected, causes a selected one of the time slots to be scheduled. Each of initial time slots 210a, 210b, and 210c is individually selectable by the user. As defined by the inviter, time slots 210 have the same initial/original duration (1 hour), and are each defined by a pair of corresponding time-of-day start and end times. In the example of FIG. 2, initial time slot 11:00 am-12:00 pm is selected.

Invitation 200 also includes a user selectable shorten option 220 that the invitee may select to shorten the duration of the time slot that is selected among time slots 210 (e.g., time slot 11:00 am-12:00 pm). If the invitee selects shorten option 220, web browser 50(2) presents shortened duration options for the selected one of initial time slots 210, as depicted in FIG. 3.

With reference to FIG. 3, there is depicted a second user interface 300 (also referred to as “shorten duration options 300”) that is displayed on web browser 50(2) if the invitee selected the shorten option from invitation 200. Shorten duration options 300 include a set of different user selectable shortened durations 310, e.g., 5 minutes, 10 minutes, 15 minutes, and so on), and a user selectable continue option 315 that, when selected, will cause the selected initial duration (e.g., 1 hour from user interface 200) to be shortened based on the selected one of the shortened durations.

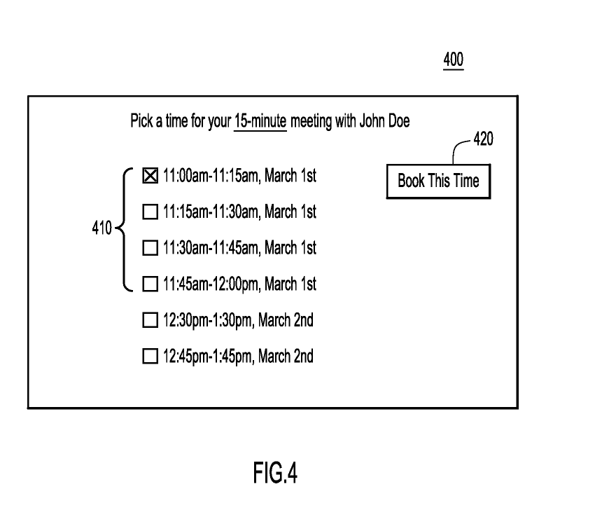

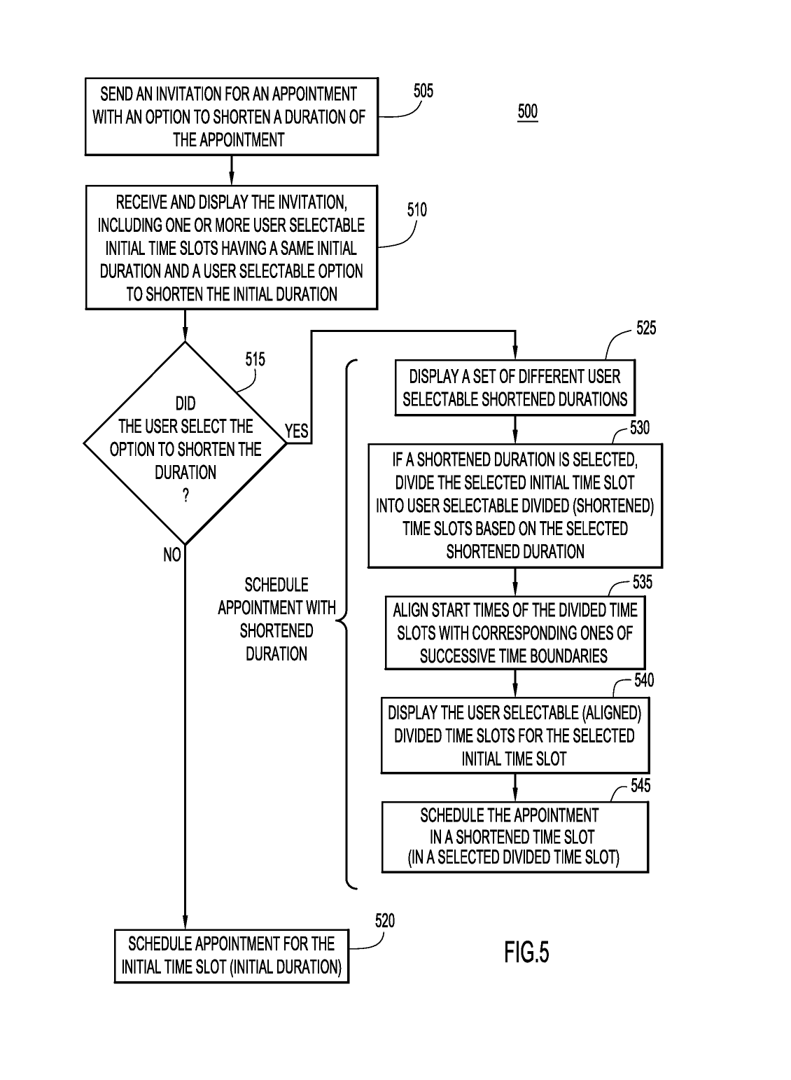

In the example of FIG. 3, the shortened duration of 15 minutes among shortened durations 310 is selected. If the invitee selects continue option 315, multiple shortened appointment time slots are computed for the initial time slot selected in user interface 200 (e.g., initial time slot 11:00 am-12:00 pm) based on the selected shortened duration (e.g., 15 minutes), and web browser 50(2) presents the shortened appointment time slots. In other words, the initial time slot selected in FIG. 2 is divided into smaller time slots, as depicted in FIG. 4.

With reference to FIG. 4, there is depicted a third user interface 400 (also referred to as “shortened appointment options 400”) displayed on web browser 50(2) if the invitee selected continue option 315 and the 15 minute shortened duration from duration options 300. The shortened duration of 15 minutes is applied to the 1 hour initial time slot 11:00 am-12:00 pm selected in user interface 200. Shortened appointment options 400 presents shortened or divided time slots 410 corresponding to initial time slot 11:00 am-12:00 pm, which has been divided into four shortened 15 minute user selectable time slots 11:00 am-11:15 pm, 11:15 am-11:30 am, 11:45 am-12:00 pm. Options 400 also present user selectable initial time slots 12:30-1:30 and 12:45-1:45 as unchanged (i.e., undivided) because neither of these initial time slots was selected for shortening from user interface 200. Options 400 also present a user selectable “Book This Time” option 420, which when selected will schedule an appointment for whichever one of time slots 410 and the initial time slots (12:30 pm-1:30 pm and 12:45-1:45 pm) is selected. In the example of FIG. 4, the shortened time slot 11:00 am-11:15 am is selected and the appointment will be scheduled for that slot.

With reference to FIG. 5, there is shown a flowchart of an example generalized method 500 of invitee-driven scheduling of an appointment in which the invitee may reduce a duration of an initially offered appointment. In method 500, web browsers associated with the inviter and the invitee exchange schedule and GUI information with each other and server 45 as necessary to support the operations of the method described below. In one example, operations to display GUIs are performed using the web browsers, while operations 515, 520, 530, 535, and 545 are performed by server 45. Also, communication between the web browsers may be made via web server 45.

At 505, an inviter creates an invitation for an appointment using a web browser associated with the inviter and sends the invitation to an invitee (e.g., invitee device 50(2)). The appointment includes one or more initially offered time slots (i.e., one or more appointment time options). The time slots may all have a same initial duration, or different initial durations. The invitation also includes an option to shorten the initially offered duration(s). Different durations to which the appointment may be shortened and time boundaries for start times of shortened appointments may be embedded in the invitation.

At 510, the invitee device receives the invitation for the appointment. A web browser associated with the invitee (the “invitee web browser”) displays the appointment, including one or more user selectable initial time slots having initial durations and a user selectable option to shorten the initial time slot duration, as created by the inviter. See the invitation depicted in FIG. 2, for example.

It is assumed that the invitee selected one of the one or more user selectable initial time slots (i.e., a selection of one of the time slots was received). At 515, it is determined whether the invitee also selected the option to shorten the initial duration (of the selected one of the user selectable time slots). If it is determined that the option to shorten is not selected, and the invitee has selected to continue with scheduling the selected initial time slot, flow proceeds to 520. At 520, the appointment is scheduled for the selected initial time slot without shortening the duration of that time slot.

On the other hand, if at 515 it is determined that the invitee also selected the option to shorten the initial duration (i.e., a selection of the option to shorten was received), flow proceeds to 525-545, where an appointment is scheduled with a shortened duration, as described below.

At 525, the invitee web browser displays a set of different user selectable shortened time slot durations. See the shortened durations depicted in FIG. 3, for example. The shortened durations may be accessed in the metadata associated with the invitation or from server 45.

At 530, if the invitee selects a shortened duration (i.e., a selection of a shortened duration was received), the selected initial time slot is divided into user selectable divided (shortened) time slots each of a duration equal to the selected shortened duration.

At 535, start times of the divided time slots are aligned with corresponding ones of successive time boundaries. The time boundaries may be accessed in the invitation metadata or from server 45. The time boundaries may be evenly spaced-apart time boundaries, e.g., shortening a 1 hour slot into 10 minute durations may produce 6 shortened contiguous appointments where there was only 1 before the 1 hour time slot was shortened. In another example, the shortened time slots may start at successive boundaries that are only 5-minutes apart such that 11 partially overlapped shortened appointments are offered within the hour. In yet another example, shortening the 1 hour down to 45 minutes could lead to time slot options that overlap the initial 1 hour boundaries (in this case, presenting the new start times every 5 minutes from the start of the hour to 15 min after).

At 540, the invitee web browser displays the user selectable divided time slots for the selected initial time slot. The invitee web browser may also display the initial time slots that were not selected for shortening so that the invitee also has the option to select one of those initial time slots.

At 545, if the invitee selects one of the shortened (divided) time slots along with a continue scheduling option, the appointment is scheduled in the selected shortened time slot.

Turning to FIG. 6, an example block diagram is shown for server 45 on which the appointment engine 20 and other functions may be running The server 45 includes a network interface unit 600 configured to enable network communications to send messages to and receive messages from, e.g., web browsers, of user devices. One or more processors 610 are provided that execute software stored in memory 620. The processor(s) 610 is, for example, a microprocessor or microcontroller. To this end, the memory 620 stores instructions for shorten appointment software/logic 630. When the one or more processors 610 execute the shorten appointment software 630, the server 45 performs the operations described herein in connection with FIGS. 1-5.

Memory 620 may comprise read only memory (ROM), random access memory (RAM), magnetic disk storage media devices, optical storage media devices, flash memory devices, electrical, optical, or other physical/tangible memory storage devices. Thus, in general, the memory 620 may comprise one or more tangible (non-transitory) computer readable storage media (e.g., a memory device) encoded with software comprising computer executable instructions and when the software is executed (by the processor(s) 610) it is operable to perform the operations described herein.

With regard to graphical user interfaces described herein, the one or more processors 610 of server 45 execute instructions to generate data for displaying the graphical user interfaces on an associated display device (e.g., to cause the display device to present the user interfaces. Also, one or more processors of devices 60 associated with respective ones of the browsers 50 depicted in FIG. 1 may also execute instructions to generate data for displaying appropriate graphical user interfaces via the browsers (e.g., to cause the browsers to present the user interfaces) as appropriate.

In summary, in one form, a method is provided comprising: displaying an invitation for an appointment, including a user selectable initial time slot having an initial duration, and a user selectable option to shorten the initial duration; if the initial time slot and the shorten option are selected, scheduling the appointment for a shortened time slot having a duration that is shorter than the initial duration and that is within the initial time slot; and if the initial time slot is selected and the shorten option is not selected, scheduling the appointment for the initial time slot.

In summary, in another form, an apparatus is provided comprising: a network interface unit configured send and receive communications over a network; a memory; and a processor coupled to the network interface unit and to the memory, and configured to: generate display data for displaying an invitation for an appointment, including a user selectable initial time slot having an initial duration, and a user selectable option to shorten the initial duration; if the initial time slot and the shorten option are selected, schedule the appointment for a shortened time slot having a duration that is shorter than the initial duration and that is within the initial time slot; and if the initial time slot is selected and the shorten option is not selected, schedule the appointment for the initial time slot.

In summary, in yet another form, a computer readable storage media is provided. The storage media stores instructions that, when executed by a processor, cause the processor to: generate display data for displaying an invitation for an appointment, including a user selectable initial time slot having an initial duration, and a user selectable option to shorten the initial duration; if the initial time slot and the shorten option are selected, schedule the appointment for a shortened time slot having a duration that is shorter than the initial duration and that is within the initial time slot; and if the initial time slot is selected and the shorten option is not selected, schedule the appointment for the initial time slot.

The above description is intended by way of example only.

What is claimed is:

1. A method comprising:
displaying an invitation for an appointment, including a user selectable initial time slot having an initial duration, and a user selectable option to shorten the initial duration;
if the initial time slot and the shorten option are selected, scheduling the appointment for a shortened time slot having a duration that is shorter than the initial duration and that is within the initial time slot; and
if the initial time slot is selected and the shorten option is not selected, scheduling the appointment for the initial time slot.

2. The method of claim 1, wherein the scheduling the appointment in a shortened time slot includes:
displaying a set of different user selectable shortened durations each shorter than the initial duration; and
if a shortened duration is selected:
dividing the initial time slot into user selectable divided time slots each of a duration equal to the selected shortened duration; and
displaying the user selectable divided time slots for the initial time slot,
wherein, if the user selects a user selectable divided time slot, the scheduling the appointment in a shortened time slot includes scheduling the appointment in the selected divided time slot.

3. The method of claim 2, wherein:
the displaying an invitation includes displaying one or more additional user selectable initial time slots; and
the method further comprises, if the shortened duration is selected, after the dividing, displaying the one or more additional user selectable initial time slots in addition to the user selectable divided time slots.

4. The method of claim 2, further comprising aligning start times of the divided time slots with corresponding ones of successive spaced-apart time boundaries.

5. The method of claim 4, further comprising accessing the shortened durations and spaced-apart time boundaries from metadata associated with the invitation.

6. The method of claim 2, wherein the displaying the user selectable divided time slots includes displaying respective time-of-day start and end times for each divided time slot.

7. The method of claim 1, further comprising sending, from an inviter to an invitee, the invitation including the user selectable initial time slot and the user selectable option to shorten the initial duration.

8. An apparatus comprising:
a network interface unit configured send and receive communications over a network;
a memory; and
a processor coupled to the network interface unit and to the memory, and configured to:
generate display data for displaying an invitation for an appointment, including a user selectable initial time slot having an initial duration, and a user selectable option to shorten the initial duration;
if the initial time slot and the shorten option are selected, schedule the appointment for a shortened time slot having a duration that is shorter than the initial duration and that is within the initial time slot; and
if the initial time slot is selected and the shorten option is not selected, schedule the appointment for the initial time slot.

9. The apparatus of claim 8, wherein the processor is configured to schedule the appointment in the shortened time slot by:
generating display data for displaying a set of different user selectable shortened durations each shorter than the initial duration; and
if a shortened duration is selected:
dividing the initial time slot into user selectable divided time slots each of a duration equal to the selected shortened duration; and
generating display data for displaying the user selectable divided time slots for the initial time slot,
wherein, if the user selects a user selectable divided time slot, the processor is configured to schedule by scheduling the appointment in the selected divided time slot.

10. The apparatus of claim 9, wherein the processor is configured to:
generate display data for displaying one or more additional user selectable initial time slots; and
if the shortened duration is selected, after the initial time slot is divided, display the one or more additional user selectable initial time slots in addition to the user selectable divided time slots.

11. The apparatus of claim 9, wherein the processor is further configured to align start times of the divided time slots with corresponding ones of successive spaced-apart time boundaries.

12. The apparatus of claim 11, wherein the processor is further configured to access the shortened durations and spaced-apart time boundaries from metadata associated with the invitation.

13. The apparatus of claim 9, wherein the processor is configured to generate data for displaying respective time-of-day start and end times for each divided time slot.

14. The apparatus of claim 8, wherein the processor is further configured to send, from an inviter to an invitee, the invitation including the user selectable initial time slot and the user selectable option to shorten the initial duration.

15. A non-transitory computer readable storage media storing instructions that, when executed by a processor, cause the processor to:
generate display data for displaying an invitation for an appointment, including a user selectable initial time slot having an initial duration, and a user selectable option to shorten the initial duration;
if the initial time slot and the shorten option are selected, schedule the appointment for a shortened time slot having a duration that is shorter than the initial duration and that is within the initial time slot; and
if the initial time slot is selected and the shorten option is not selected, schedule the appointment for the initial time slot.

16. The computer readable storage media of claim 15, wherein the instructions to cause the processor to schedule include instructions to cause the processor to:
generate display data for displaying a set of different user selectable shortened durations each shorter than the initial duration; and
if a shortened duration is selected:
divide the initial time slot into user selectable divided time slots each of a duration equal to the selected shortened duration; and
display the user selectable divided time slots for the initial time slot,
wherein the instructions include instructions to cause the processor to, if the user selects a user selectable divided time slot, schedule the appointment in the selected divided time slot.

17. The computer readable storage media of claim 16, wherein the instructions include instructions to cause the processor to:
generate display data for displaying one or more additional user selectable initial time slots; and
if the shortened duration is selected, after the initial time slot is divided, generate display data for displaying the one or more additional user selectable initial time slots in addition to the user selectable divided time slots.

18. The computer readable storage media of claim 16, further comprising instructions to cause the processor to align start times of the divided time slots with corresponding ones of successive spaced-apart time boundaries.

19. The computer readable storage media of claim 18, further comprising instructions to cause the processor to access the shortened durations and spaced-apart time boundaries from metadata associated with the invitation.

20. The computer readable storage media of claim 16, wherein the instruction include instructions to generate data for displaying respective time-of-day start and end times for each divided time slot.
